(19) United States
(12) Patent Application Publication
(10) Pub. No.: US 2015/0169652 A1
(43) Pub. Date: Jun. 18, 2015

(54) SYSTEMS AND METHODS FOR AUTOMATED REPORT GENERATION

(71) Applicant: 1C LLC, Moscow (RU)

(72) Inventors: Sergey Georgievich Nuraliev, Moscow (RU); Maxim Mikhaylovich Leybovich, Moscow (RU)

(73) Assignee: 1C LLC

(21) Appl. No.: 14/635,475

(22) Filed: Mar. 2, 2015

Related U.S. Application Data
(63) Continuation-in-part of application No. PCT/RU2013/000040, filed on Jan. 21, 2013.

(51) Int. Cl. G06F 17/30

(52) U.S. Cl. CPC G06F 17/30292

(57) ABSTRACT

Disclosed are systems, methods and computer program products for automated report generation. Provided is a set of technological tools having customization options including customization settings that are user friendly to end users. The method involves creation of a data structuring schema for report generation with customizable query text, data sets, data links, available report fields, and data retrieval parameters, specifying default data structuring settings, generating a report template according to the created data structuring schema and specified data structuring settings, and generating a report based on the template.

### CROSS-REFERENCE TO RELATED APPLICATIONS

This application is a continuation-in-part of the International Application No. PCT/RU2013/000040 filed Jan. 21, 2013, incorporated herein by reference in its entirety, and claims benefit of priority to Russian Patent Application No. 2012144538 filed Oct. 31, 2012, incorporated herein by reference in its entirety.

### TECHNICAL FIELD

The present disclosure relates generally to the field of electronic report generation, and more specifically to systems and methods for automated report generation.

### BACKGROUND

Known methods for report generation involve manually writing the software code to retrieve data, create a report template, write the retrieved data to the template, and display the result to the end user. However, such methods do not enable customization options and limit usage areas.

One known method of report generation includes a graphical tool for defining the data model that contains data objects, such as queries, links or groups. The model is then used to create a data structure, define a data model template, and generate a report. This method allows the use of multiple queries, each containing one or more groups, where groups belonging to two different queries are linked through link objects. The resulting report can have a complex structure and it can include the results of multiple queries, which provides additional flexibility. However, generating a modified report may take a long time and thus the usefulness of this method is limited.

### SUMMARY

Automated report generation addresses the challenge of creating complex reports with flexible configuration, modification options, and ways to display data that has complicated structure. This can be solved using various approaches.

Disclosed are systems, methods and computer program products for automated report generation. In one example aspect, a computer-implemented method for automatically generating a report comprising: receiving default data structuring settings via a processor and storing the default data structuring settings in a repository accessible by the processor; creating a data structuring schema via a data structuring module stored on the processor, and storing the created data structuring schema in the repository; receiving user settings via a user interface associated with the processor; generating a report template via a report template module stored on the processor, wherein the report template is generated based on the created data structuring schema and one or more of the default data structuring settings and the user settings; and generating a customizable report based on the generated report template, wherein a report modification module stored on the processor is configured to modify the customizable report based on input data comprising one or more of query text, data sets, data links, available report fields and data retrieval parameters, the report modification module being configured to receive the input data via the user interface.

In another example aspect, a system for automatically generating a report comprising: a processor; a user interface functioning via the processor; and a repository accessible by the processor; wherein the processor is configured to: receive default data structuring settings and store the default data structuring settings in the repository; create a data structuring schema via a data structuring module stored on the processor, and store the created data structuring schema in the repository; receive user settings via the user interface; generate a report template via a report template module stored on the processor, wherein the report template is generated based on the created data structuring schema and one or more of the default data structuring settings and the user settings; and generate a customizable report based on the generated report template, wherein a report modification module stored on the processor is configured to modify the customizable report based on input data comprising one or more of query text, data sets, data links, available report fields and data retrieval parameters, the report modification module being configured to receive the input data via the user interface.

Some aspects further comprise receiving the input data from script objects. In some aspects, the step of generating the customizable report comprises modifying the generated report template based on a data structuring schema of a data set query and based on fields and filters comprised by the user settings. In some aspects, the data structuring schema comprises modifiable query fragments. In some aspects, the data structuring schema comprises data from multiple data sets. In some aspects, each of the multiple data sets comprise linked data, the method further comprising providing data links to retrieve the linked data, wherein the data links comprise hierarchical links between the multiple data sets. In some aspects, creating a data structuring schema further comprises creating a plurality of data structuring schemas, wherein the plurality of data structuring schemas are nested. Some aspects further comprise receiving modified data structuring settings via the processor and storing the modified data structuring settings in the repository; generating a specific report template based on the modified data structuring settings; and generating a specific report based on the generated specific report template. In some aspects, the data structuring schema comprises report field display settings. In some aspects, the generated customizable report comprises a subset of report settings configured to be modified based on an input received via the user interface. In some aspects, generating a report template further comprises: generating a plurality of report templates based on a plurality of data structuring settings; and storing each of the plurality of data structuring settings associated with each of the plurality of report templates in the repository. In some aspects, the generated customizable report comprises reference fields having subordinate fields. Some aspects further comprise modifying one or more of the default data structuring settings and input settings based on information within the generated customizable report. In some aspects, the query text comprises data set query templates having specific fragments marking modifiable query parts.

The above simplified summary of example aspects serves to provide a basic understanding of the disclosure. This summary is not an extensive overview of all contemplated aspects, and is intended to neither identify key or critical elements of all aspects nor delineate the scope of any or all aspects of the disclosure. Its sole purpose is to present one or more aspects in a simplified form as a prelude to the more detailed description of the disclosure that follows. To the accomplishment of the foregoing, the one or more aspects of the disclosure include the features described and particularly pointed out in the claims.

### BRIEF DESCRIPTION OF THE DRAWINGS

The accompanying drawings, which are incorporated into and constitute a part of this specification, illustrate one or more example aspects of the disclosure and, together with the detailed description, serve to explain their principles and implementations.

FIG. 1 is a flow diagram illustrating an example method for automated report generation according an aspect.

FIG. 2 is a diagram illustrating an example configuration of an automated report generation system according to an aspect.

FIG. 3 is a diagram illustrating an example general-purpose computer system on which the systems and methods for automated report generation can be deployed according to aspects.

FIG. 4 is a screenshot of user interface for selecting the user settings that can be altered by the users in an example aspect.

FIG. 5 is a screenshot showing a data structuring schema.

FIG. 6 is a screenshot showing nested data structuring schemas in an example aspect.

FIGS. 7A, 7B, and 7C show screenshots of a variety of user settings in example aspects where the user defines selection of fields, their groupings, and a filter.

### DETAILED DESCRIPTION

Example aspects of the present disclosure are described herein in the context of systems, methods, and computer program products, for automated report generation. The disclosed system and methods provide a general and relatively fast mechanism of automated report generation, including options for report modification and convenient configuration for end users. The disclosed system and methods therefore are free of the disadvantages of the known solutions.

Those of ordinary skill in the art will realize that the following description of example aspects of system and methods for automatic report generation is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same items.

A report shows a collection of data (or field values for the report fields) selected from one or several data sets, for example, from one or several databases, in a form preferable to a user. These values may be manipulated, for example, by formatting or by mathematical formulae, before being put into a report. A report may, for example, be displayed on a computer screen or printed on paper. Automated report generation may involve, for example, automated positioning of reported data on the screen, automated formatting of the reported data, automated placement of explanations for the reported data.

The report is generated using a report template. The report template provides information regarding how to obtain data from data sets, and how to generate a report from these data.

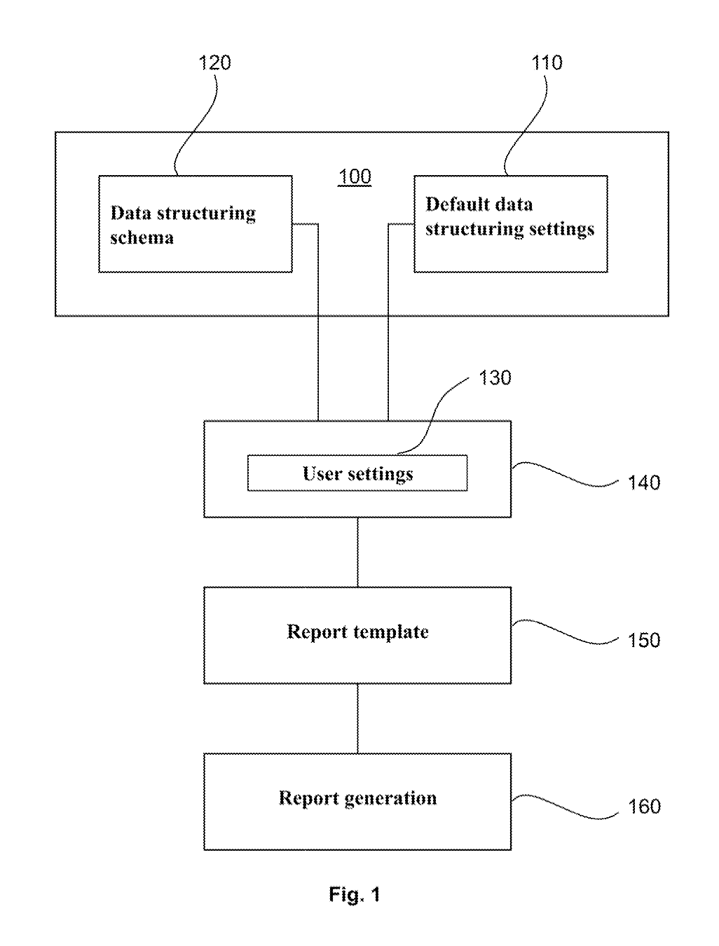

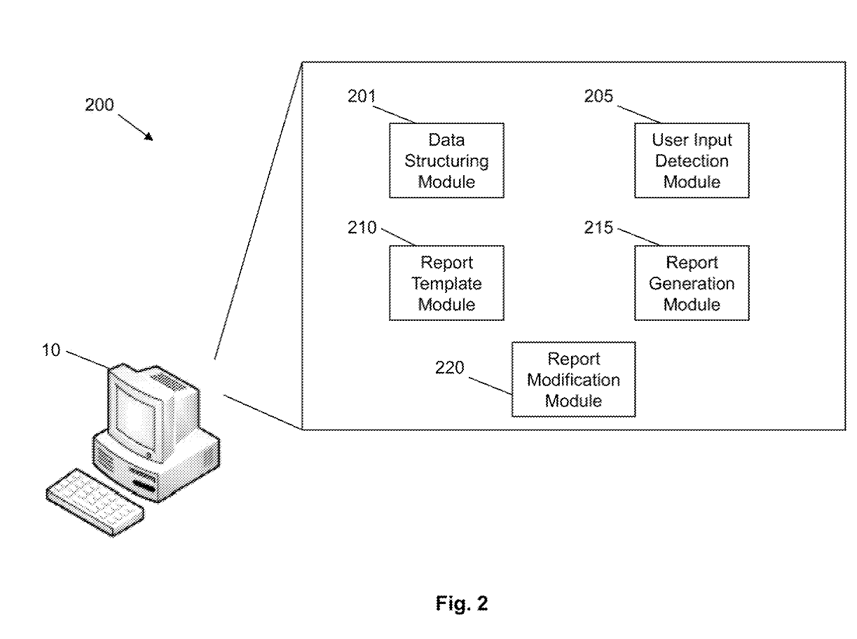

FIG. 1 shows an example of an automated report generation method according to one aspect of the disclosure. The method may be implemented by an automated report generation system 200 shown in FIG. 2 (described below).

At step 100, the method includes receiving and storing in a memory 20 a data structuring schema 120. In one aspect, the data structuring schema 120 may be set by a developer.

In another aspect, the system 200 can receive (e.g., from a developer) and store (e.g., in a memory 20) a single or multiple sets of default data structuring settings 110 configured by a developer for generation of a report template at step 150.

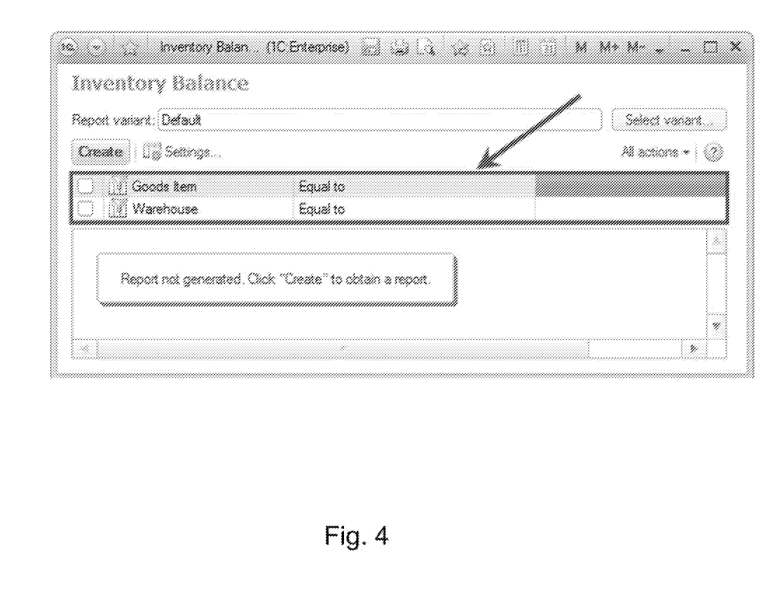

As shown in FIG. 4, the developer selects which of the data structuring settings are available for editing by the end users as user settings.

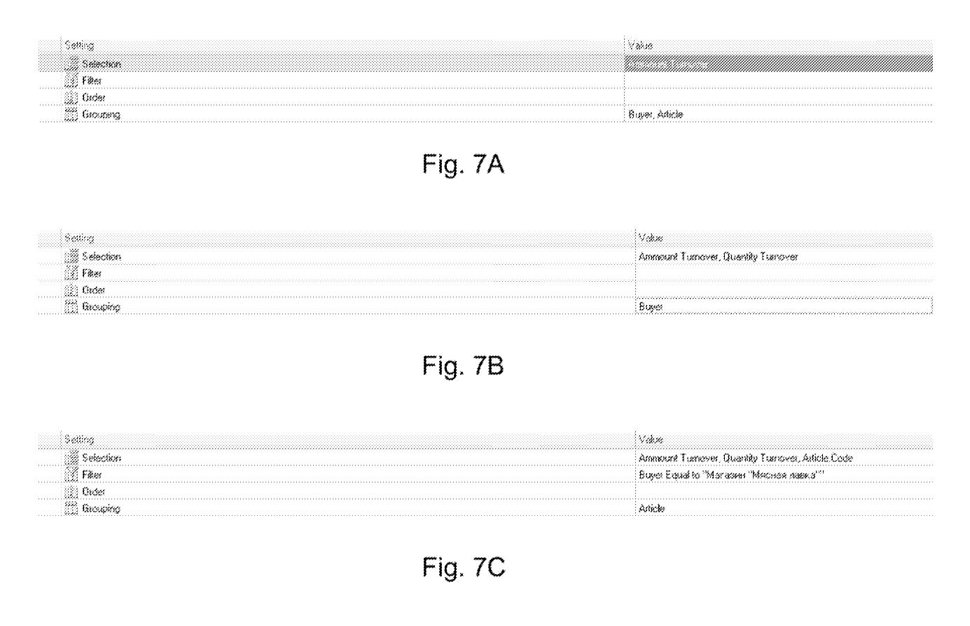

At step 140, the method includes receiving user settings 130 from a user device 10 and/or input by a developer. These user settings 130 are stored in a memory 20 and accessible by the user device 10 and the modules of the system 200. In some instances, the default user settings 110 may be used in the method “as is,” without further modification by the user. In another aspect, the system 200 is configured for the end user to edit generated report templates and to store variations of the report templates in the memory 20 for future use. The system 200 is also configured for the end user to edit or modify the data structuring settings and to generate a specific report template based on these modified settings. FIGS. 7A, 7B, and 7C show screenshots of a variety of user settings in example aspects where the user defines selection of fields, their groupings, and a filter.

The specific report template may then be used to generate a specific report and the system 200 is configured to store various user selections, report templates, and specific reports in the memory 20. Therefore, an end user can later use the stored report templates to minimize the number of settings that require editing. Thus, the report generation method of the present disclosure is simplified as compared to prior art report generation methods.

At step 150, the system 200 is configured to generate a report template. The generated report template 150 is based on the created data structuring schema and the default data structuring settings 110 and/or modified data structuring settings stored in the memory 20 and accessible to the report template module 210.

At step 160, the method includes generating the report according to the template generated at step 150. Therefore, the method and system 200 are configured to modify the data structuring to create a specific report template. The user settings provided by the user at step 140 indicate specific data fields to be used in the report and how to select and filter them. In this way the user can to a certain extent modify the final content of the request or set of requests. In response to these requests a new data structure would be received thus forming a new report template.

The automated report generation method provides fast generation of reports having complex hierarchical structure. The reports are customizable by end users through a user interface on a user device 10, that is, the reports can be customized by end users without the need to involve a software developer.

In one aspect the method includes creating a data structuring schema 120 for report generation before step 100. The developer prepares a skeleton request for the report which can be reduced or expanded (for example, to include more fields) using the default data structuring settings 110, the modified data structuring settings, and the user settings 130.

The data structuring settings describe everything a developer or a user can set in a data structuring schema. The data structuring settings can include: filtering, ordering, conditional appearance, report structure (parts of the future report), data receiving parameters, and data output parameters.

A report template is a description of how to create a report. It combines data structuring schemas and data structuring settings. It results from applying specific settings to a structuring schema and represents a finished task for the composition processor to generate a report with the required structure and specified settings. The data structuring schema is the basis for report generation; it describes where to receive data from and how to manage data composition, and it may refer to several data sets.

The created data structuring schema 120 provides options for detailed description of input data including query text with the data structuring system instructions, description of data sets, data links, available report fields, data retrieval and receiving parameters, and descriptions of field and group templates, and recording the schema to a memory or other storage 20.

The data structuring schema 120 describes and configures the data that is fundamentally used for report generation. In one aspect, the data structuring schema 120 can contain different data sets. The creation of a report data structuring schema can be performed interactively by developers using visual tools, or in any visual XML editor, or programmatically using script objects.

Script objects are defined as a structured set of program objects that have specific functional purposes. Data sets are report data sources, which describe how that data is retrieved. There are various data set types: a query that includes a database query text written in the query language with use of additional syntax elements, a script object that contains information about an external data set (such as a value table), or a data set that combines data from multiple data sets.

A data set query describes a query template, which is modified during report generation according to fields and filters specified in the settings, for example, the default data structuring settings and/or user settings. Query templates are described in the query language, with specific syntax units marking query parts that can be modified. The modification is performed within these syntax units. The result contains only the required data instead of all data selected in the original query.

If a data structuring schema contains multiple data sets, in order to retrieve linked data from these data sets, data links by one or several report fields must be specified. Hierarchical links between data sets can be described. Hierarchical links are used for writing data sets where records are linked to other records by some report fields to the resulting document. Available fields are defined as report fields available to the data structuring schema. They can be included in report settings, such as sorting, filtering, or grouping. Parameters serve as criteria for retrieving report data. They can be defined directly in a data set query, or they can be parameters of virtual database tables.

The resulting report structure is defined by a tree-like description (not by specifying the positions of individual elements on the report sheet).

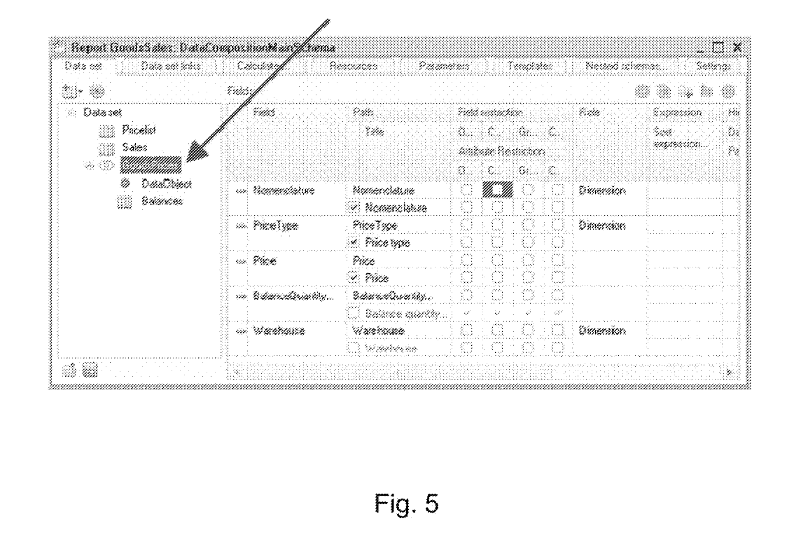

FIG. 5 shows a screenshot of a sample data structuring schema being set up by a developer before any user settings are added.

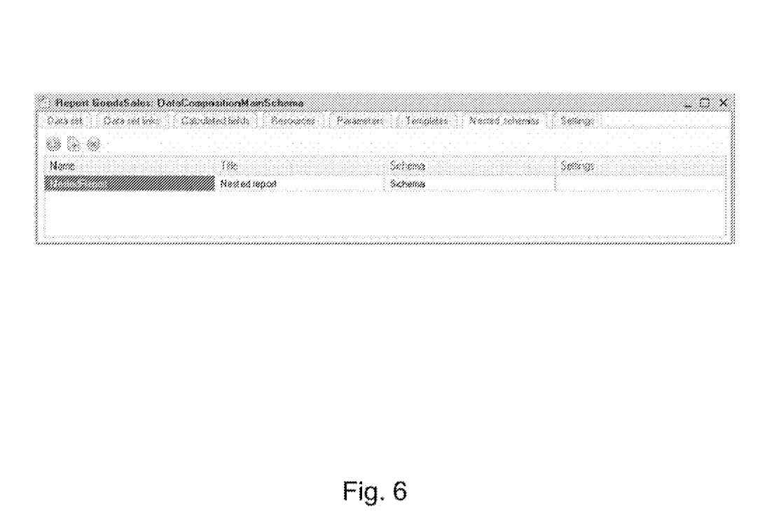

Adding nested data structuring schemas is also possible, as shown in FIG. 6. Thereby, a structuring schema designed for a specific report can be reused in other reports by linking the parent report and the nested report by one or several fields.

In a further aspect, the default data structuring settings, which define the report layout, are specified and the report template is formed according to the created data structuring schema and the specified data structuring settings. Finally, the report is generated according to the created template.

FIG. 2 depicts an example configuration of a system 200 for automated report generation according to aspects of the disclosure. The disclosure can be implemented as a software application, a desktop widget, an applet, a script, or other type of software program code executable on a computer device 10, such as a PC, tablet, notebook, smart phone, or other type of computer device or computation system. The implementation requires an information base, storage or system memory 20 that contains multiple objects used in report generation. As shown in FIG. 2, the system 200 may have a plurality of modules, including but not limited to a data structuring module 201, a user input detection module 205, a report template module 210, a report generation module 215 and a report modification module 220. In one aspect, the user input detection module 205 is configured to receive input data containing default data structuring settings and modified data structuring settings. These data structuring settings may be received from a user interface, such as a graphical user interface.

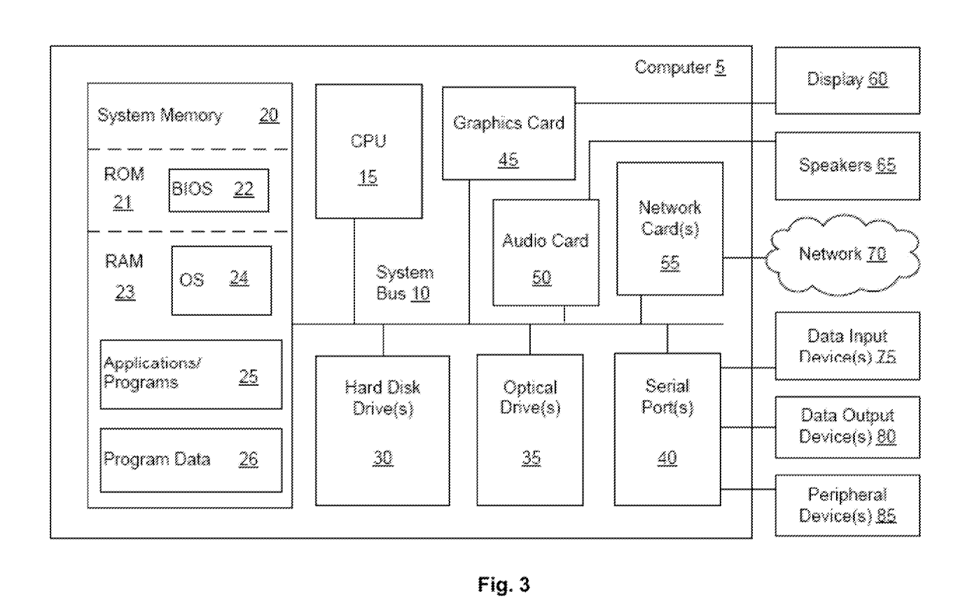

The term “module” as used herein means a real-world device, apparatus, or arrangement of modules implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer (such as the one described in greater detail in FIG. 3 below). Accordingly, each module can be realized in a variety of suitable configurations, and should not be limited to any particular implementation exemplified herein.

The system 200 is configured so that an end user has the option to modify the report settings directly from a generated report using the report modification module 220 accessible through a user interface on the user device 10. For example, a user can click a cell, and then select “filter” or “group” from a pop-up menu. This changes the report settings so that the report is filtered or grouped by the selected field.

The system 200 is further configured so that an end user can select a report variation that the end user finds most useful. The report modification module 220 is further configured so that the end user can customize the user settings and obtain a different report based on the same data structuring schema where data is represented according to the user settings. Therefore, the system 200 is configured so that a single structuring schema generated by the data structuring module 201 can be used for creating multiple reports using the report generation module 215. The data structuring settings that are supplied define the final result.

In one aspect of the disclosure, the end user does not have to specify exactly where fields will be displayed in the generated report sheet (both for viewing on the screen and for printing). The end user can simply input through a user interface that the field should be included in the report, and the report generation module 215 is configured to position the field on the generated report sheet according to an optimal positioning schema that is predefined in the software and report generation module 215.

In one aspect, the system 200 is configured to use subordinate fields of reference fields in the report settings. For example, if a report includes an “Item” field, using the report modification module 220, a user can add the “Item.ID” field to the list of fields displayed in the report. This results in automatic modification of the data set query and displaying the “ID” field at the required position. The user can also add a filter by the “Item.ID” field, which results in automatic addition of the corresponding condition to the data set query text, and thus generating filtered data.

FIG. 3 depicts one example aspect of a computer system 5 that can be used to implement the disclosed systems and methods for automated report generation. The computer system 5 may include, but is not limited to, a personal computer, a notebook, tablet computer, a smart phone, a network server, a router, or other type of processing device. As shown, computer system 5 may include one or more hardware processors 15, memory 20, one or more hard disk drive(s) 30, optical drive(s) 35, serial port(s) 40, graphics card 45, audio card 50 and network card(s) 55 connected by system bus 10. System bus 10 may be any of several types of bus structures including a memory bus or memory controller, a peripheral bus and a local bus using any of a variety of known bus architectures. Processor 15 may include one or more Intel® Core 2 Quad 2.33 GHz processors or other type of microprocessor.

System memory 20 may include a read-only memory (ROM) 21 and random access memory (RAM) 23. Memory 20 may be implemented as in DRAM (dynamic RAM), EPROM, EEPROM, Flash or other type of memory architecture. ROM 21 stores a basic input/output system 22 (BIOS), containing the basic routines that help to transfer information between the modules of computer system 5, such as during start-up. RAM 23 stores operating system 24 (OS), such as Windows® 7 Professional or other type of operating system, that is responsible for management and coordination of processes and allocation and sharing of hardware resources in computer system 5. Memory 20 also stores applications and programs 25. Memory 20 also stores various runtime data 26 used by programs 25.

Computer system 5 may further include hard disk drive(s) 30, such as SATA HDD, and optical disk drive(s) 35 for reading from or writing to a removable optical disk, such as a CD-ROM, DVD-ROM or other optical media. Drives 30 and 35 and their associated computer-readable media provide non-volatile storage of computer readable instructions, data structures, applications and program modules/subroutines that implement algorithms and methods disclosed herein. Although the exemplary computer system 5 employs magnetic and optical disks, it should be appreciated by those skilled in the art that other types of computer readable media that can store data accessible by a computer system 5, such as magnetic cassettes, flash memory cards, digital video disks, RAMs, ROMs, EPROMs and other types of memory may also be used in alternative aspects of the computer system 5.

Computer system 5 further includes a plurality of serial ports 40, such as Universal Serial Bus (USB), for connecting data input device(s) 75, such as keyboard, mouse, touch pad and other. Serial ports 40 may be also be used to connect data output device(s) 80, such as printer, scanner and other, as well as other peripheral device(s) 85, such as external data storage devices and the like. System 5 may also include graphics card 45, such as nVidia® GeForce GT 240M or other video card, for interfacing with a display 60 or other video reproduction device, such as touch-screen display. System 5 may also include an audio card 50 for reproducing sound via internal or external speakers 65. In addition, system 5 may include network card(s) 55, such as Ethernet, Wi-Fi, GSM, Bluetooth or other wired, wireless, or cellular network interface for connecting computer system 5 to network 70, such as the Internet.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In the interest of clarity, not all of the routine features of the aspects are disclosed herein. It will be appreciated that in the development of any actual implementation of the disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The system and methods of automated report generation described herein enrich the set of technological tools having fast and multi-purpose report generation available to end user. The system and methods provide customization options and increased usability of customization settings available to end users. The systems and methods are therefore free of the disadvantages of known solutions.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the concepts disclosed herein.

1. A computer-implemented method for automatically generating a report comprising:
receiving a data structuring schema via a data structuring module stored on the processor, and storing the created data structuring schema in the repository;
receiving default data structuring settings via a processor and storing the default data structuring settings in a repository accessible by the processor;
receiving user settings via a user interface associated with the processor;
generating a report template via a report template module stored on the processor, wherein the report template is generated based on the created data structuring schema and one or more of the default data structuring settings and the user settings; and
generating a customizable report based on the generated report template, wherein a report modification module stored on the processor is configured to modify the customizable report based on input data comprising one or more of query text, data sets, data links, available report fields and data retrieval parameters, the report modification module being configured to receive the input data via the user interface.

2. The method of claim 1 further comprising receiving the input data from script objects.

3. The method of claim 1, wherein the step of generating the customizable report comprises modifying the generated report template based on a data structuring schema of a data set query and based on fields and filters comprised by the user settings.

4. The method of claim 1, wherein the data structuring schema comprises modifiable query fragments.

5. The method of claim 1, wherein the data structuring schema comprises data from multiple data sets.

6. The method of claim 5, wherein each of the multiple data sets comprise linked data, the method further comprising providing data links to retrieve the linked data, wherein the data links comprise hierarchical links between the multiple data sets.

7. The method of claim 1, wherein creating a data structuring schema further comprises creating a plurality of data structuring schemas, wherein the plurality of data structuring schemas are nested.

8. The method of claim 1 further comprising:
receiving modified data structuring settings via the processor and storing the modified data structuring settings in the repository;
generating a specific report template based on the modified data structuring settings; and
generating a specific report based on the generated specific report template.

9. The method of claim 1, wherein the data structuring schema comprises report field display settings.

10. The method of claim 1, wherein the generated customizable report comprises a subset of report settings configured to be modified based on an input received via the user interface.

11. The method of claim 1, wherein generating a report template further comprises:
generating a plurality of report templates based on a plurality of data structuring settings; and
storing each of the plurality of data structuring settings associated with each of the plurality of report templates in the repository.

12. The method of claim 1, wherein the generated customizable report comprises reference fields having subordinate fields.

13. The method of claim 1 further comprising modifying one or more of the default data structuring settings and input settings based on information within the generated customizable report.

14. The method of claim 1, wherein the query text comprises data set query templates having specific fragments marking modifiable query parts.

15. A system for automatically generating a report comprising:
a processor;
a user interface functioning via the processor; and
a repository accessible by the processor;
wherein the processor is configured to:
receive a data structuring schema via a data structuring module stored on the processor, and store the created data structuring schema in the repository;
receive default data structuring settings and store the default data structuring settings in the repository;
receive user settings via the user interface;
generate a report template via a report template module stored on the processor, wherein the report template is generated based on the created data structuring schema and one or more of the default data structuring settings and the user settings; and
generate a customizable report based on the generated report template, wherein a report modification module stored on the processor is configured to modify the customizable report based on input data comprising one or more of query text, data sets, data links, available report fields and data retrieval parameters, the report modification module being configured to receive the input data via the user interface.

16. The system of claim 15, wherein the processor is configured to receive the input data from script objects.

17. The system of claim 15, wherein the processor is further configured to modify the generated report template based on a data structuring schema of a data set query and based on fields and filters comprised by the user settings.

18. The system of claim 15, wherein the data structuring schema comprises data from multiple data sets that comprise linked data, and the processor being further configured to provide data links to retrieve the linked data, wherein the data links comprise hierarchical links between the multiple data sets.

19. The system of claim 15, wherein the processor is configured to create a plurality of data structuring schemas, wherein the plurality of data structuring schemas are nested.

20. A computer program product, stored on a non-transitory computer readable medium, for automatically generating a report, wherein the computer program product includes computer executable instructions for:
receive a data structuring schema via a data structuring module stored on the processor, and storing the created data structuring schema in the repository;
receiving default data structuring settings via a processor and storing the default data structuring settings in a repository accessible by the processor;
receiving user settings via a user interface associated with the processor;
generating a report template via a report template module stored on the processor, wherein the report template is generated based on the created data structuring schema and one or more of the default data structuring settings and the user settings; and
generating a customizable report based on the generated report template, wherein a report modification module stored on the processor is configured to modify the customizable report based on input data comprising one or more of query text, data sets, data links, available report fields and data retrieval parameters, the report modification module being configured to receive the input data via the user interface.
